(19) United States
(12) Patent Application Publication
(10) Pub. No.: US 2015/0100329 A1
(43) Pub. Date: Apr. 9, 2015

(54) COMPUTER IMPLEMENTED HEALTH CARE PAYMENT PROCESSING APPARATUS, SYSTEM, AND METHOD

(71) Applicants: Daniel W. Dreyfuss, Pepper Pike, OH (US); Michael T. Williams, Brunswick, OH (US)

(72) Inventors: Daniel W. Dreyfuss, Pepper Pike, OH (US); Michael T. Williams, Brunswick, OH (US)

(21) Appl. No.: 14/046,649

(22) Filed: Oct. 4, 2013

(51) Int. Cl. G06F 19/00

(52) U.S. Cl. CPC G06F 19/328
USPC 705/2

(57) ABSTRACT

Systems, methodologies, media, and other embodiments associated with a health care payment processing system are described. One exemplary system embodiment includes a computer implemented method of health care payment processing including receiving health care insurance information pertaining to a patient, the information including the patient's identity and health care insurance carrier information or health care exchange information, adding the health care insurance information to a premium assistor database, determining eligibility of the patient for health care insurance premium payment assistance based on a status of a health care insurance premium payment for verified health care insurance coverage, paying a health care insurance premium payment associated with the status of the health care insurance premium payment, verifying receipt of the health care insurance premium payment, and verifying receipt of a health care services payment from a health care insurance carrier.

### BACKGROUND

Health care system includes health care providers, health care insurance carriers, and patients. Health care providers employ health care professionals, such as doctors and nurses, who attend to the patients' medical issues. Health care insurance providers receive premiums either from each patient or on behalf of each patient in exchange for paying a portion of health care service charges incurred by a patient during a period of health care insurance coverage.

Patients typically schedule appointments to visit a health care provider, which provides notice ahead of time to the health care provider. Occasionally patients make emergency visits, which may not provide any notice to health care providers. During these visits health care providers provide health care service, which may result in health care service charges that the health care insurance carrier will be partially responsible for.

Recently the United States passed legislation titled the Affordable Care Act (“ACA”). The ACA will provide Federal funding for people to purchase health care insurance through health care exchanges. The federal funding will be in the form of either a tax credit or direct payment in some cases. The concept of the health care exchanges is to allow health care insurance carriers to sell insurance to people through the health care exchanges. The health care insurance carriers may receive either a credit or Federal funding, and individuals will pay health care insurance premiums to maintain health care insurance for themselves and their dependants or beneficiaries.

### SUMMARY

A problem that arises is that, when a patient fails to pay their health care insurance premium, the patient may be subject to retroactive disenrollment of their health insurance benefits. Retroactive disenrollment renders the health care provider unpaid for the patient's health care service charge during the retroactive period. The present application solves this problem in multiple ways. For example, a premium assistor may receive health care insurance information pertaining to the patient so that the patient's health care insurance premium may be paid prior to retroactive disenrollment. The health care insurance information may include an assignment of benefits or rights, giving the health care provider authority to pay a health care insurance premium on behalf of the patient.

Another problem that arises is that a health insurance carrier may pay a health care provider for a health care service rendered to a patient and later the health insurance carrier may retroactively disenroll the patient from their health insurance benefits. Retroactive disenrollment renders the health care provider liable to the health insurance carrier for the money the health insurance carrier paid to the health care provider for health care service provided during the retroactive period. The present application solves this problem in multiple ways. For example, a premium assistor may receive health care insurance information pertaining to the patient so that the patient's health care insurance premium may be paid and the health care provider may retain the money the health insurance carrier paid. The health care insurance information may include an assignment of benefits or rights, giving the health care provider authority to pay a health care insurance premium on behalf of the patient.

A computer implemented method of health care payment processing may include receiving health care insurance information pertaining to a patient, the health care insurance information including the patient's identity and health care insurance carrier information or health care exchange information, verifying whether the patient has valid health care insurance coverage, if valid health care insurance coverage is verified, then determining a status of a health care insurance premium payment for the verified health care insurance coverage, adding the health care insurance information to a premium assistor database, determining eligibility of the patient for health care insurance premium payment assistance based on the status of the health care insurance premium payment determined based on the health care insurance information, paying a health care insurance premium payment associated with the status of the health care insurance premium payment, verifying receipt of the health care insurance premium payment, and verifying receipt of a health care services payment from the health care insurance carrier.

A computer implemented method of health care payment processing may include receiving health care insurance information pertaining to a patient, the health care insurance information including the patient's identity and health care insurance carrier information or health care exchange information, verifying the patient has valid health care insurance coverage, determining a status of a health care insurance premium payment based on the health care insurance information, and transmitting the health care insurance information to a premium assistor.

Optionally, a computer implemented method of health care payment processing may also include determining whether the patient's information includes an assignment of benefits.

Optionally, the receiving health care insurance information includes receiving at least some patient information from the patient.

Optionally, the receiving health care insurance information includes receiving at least some patient information from a health care insurance carrier.

Optionally, if the verifying the patient has valid health care insurance step verifies that the patient has valid health care insurance, then determining the status of the health care insurance premium payment.

Optionally, if it is determined that the patient has valid health care insurance coverage, then verifying the patient has valid health care insurance coverage.

Optionally, if the determining a status of the health care insurance premium payment step determines the premium payment status is in arrears, then transmitting the health care insurance information to a premium assistor.

Optionally, the computer implemented method of health care payment processing may include receiving notification of premium due information from a premium assistor.

Optionally, the computer implemented method of health care payment processing may include adding an identifier of the patient to a screening list to indicate the patient received assistance from the premium assistor to pay a premium for the valid health care insurance coverage.

Optionally, the computer implemented method of health care payment processing may include determining whether the patient transferred coverage to another health insurance carrier.

A computer implemented method of health care payment processing including receiving health care insurance information pertaining to a patient, the information including the patient's identity and health care insurance carrier information or health care exchange information, adding the health care insurance information to a premium assistor database, determining eligibility of the patient for health care insurance premium payment assistance based on a status of a health care insurance premium payment for verified health care insurance coverage, paying a health care insurance premium payment associated with the status of the health care insurance premium payment, verifying receipt of the health care insurance premium payment, and verifying receipt of a health care services payment from a health care insurance carrier.

Optionally, the computer implemented method of health care payment processing may include receiving premium assistance eligibility information.

Optionally, if the premium assistance eligibility information does not include an assignment of benefits, then receiving an assignment of benefits from the patient or a third party.

Optionally, the computer implemented method of health care payment processing may include transferring the health care insurance information and the premium assistance eligibility information to a health care premium work list to indicate the patient may be eligible for health care insurance premium payment assistance.

Optionally, if the determining eligibility of the patient for health care insurance premium payment assistance step determines that the patient is eligible for health care insurance premium payment assistance, then transferring the health care insurance information and the premium assistance eligibility information to the health care premium work list.

Optionally, the receiving premium assistance eligibility information includes receiving at least some patient information from the patient.

Optionally, the receiving premium assistance eligibility information includes receiving at least some patient information from the health care insurance carrier.

Optionally, if the determining eligibility of the patient for health care insurance premium payment assistance step determines that the patient is eligible for health care insurance premium payment assistance, then paying the health care insurance premium payment.

Optionally, the computer implemented method of health care payment processing may include receiving premium due information from the healthcare insurance carrier.

Optionally, the computer implemented method of health care payment processing may include transmitting notification of premium due information to a health care provider.

Optionally, the computer implemented method of health care payment processing may include verifying a health care service date of the patient is within a health care coverage period paid for with the health care insurance premium payment.

Optionally, the computer implemented method of health care payment processing may include transmitting a request for at least a portion of a health care service charge associated with the patient to the health care insurance carrier.

Optionally, if the request for at least a portion of a health care service charge associated with the patient denied or the health care insurance carrier requires additional information, then transmitting the additional information to the health care insurance carrier.

Optionally, the computer implemented method of health care payment processing may include transmitting a request for payment of premium assistor charges to the health care provider.

Optionally, if verifying receipt of the services payment from the health care insurance carrier step verifies the receipt of the services payment, then transmitting the request for payment of premium assistor charges to the health care provider.

Optionally, the computer implemented method of health care payment processing may include adding an identifier of the patient to a follow up alert list to indicate the patient received assistance from a premium assistor to pay a premium for valid health care insurance coverage.

Optionally, if the patient transferred coverage to another health care insurance carrier, then receiving benefit verification and retroactive authorization of treatment and billing the another health care insurance carrier.

Optionally, the computer implemented method of health care payment processing may include verifying a request for at least a portion of a health care service charge associated with the patient is processing in the ordinary course of business.

Optionally, if incomplete health care insurance information is received from a health care provider, then receiving health care insurance information pertaining to the patient from other than the health care provider.

Optionally, the computer implemented method of health care payment processing may include scanning hospital database to identify at risk claims.

Optionally, the computer implemented method of health care payment processing may include verifying that the health care provider has a signed assignment of benefits.

A computer implemented method of health care payment processing including the steps of: receiving health care insurance information pertaining to a patient, the health care insurance information including the patient's identity and health care insurance carrier information or health care exchange information, responding to an inquiry regarding whether the patient has health care insurance, responding to an inquiry associated with a status of a health care insurance premium payment triggering addition of the health care insurance information to a database, receiving the health care insurance premium payment from a premium assistor for a health care insurance premium the patient owes, responding to a verification request regarding payment of the health care insurance premium, and if the health care insurance premium payment is received, then paying a health care insurance claim in response to receiving payment for the health care insurance premiums.

A health care payment processing system including a health care provider database configured to store health care information pertaining to a patient and configured to store received health care insurance information pertaining to the patient, a health care provider server electronically communicable with the health care provider database and configured to receive health care insurance information pertaining to the patient including a receiver electronically communicable with a health care provider server and configured to receive health care insurance information pertaining to the patient, the health care information including the patient's identity and health care insurance carrier information or health care exchange information, a verifier configured to verify the patient has valid health care insurance coverage, a determiner configured to determine a status of a health care insurance premium payment for the verified health care insurance coverage, and a transmitter configured to transmit the health care insurance information to a premium assistor.

The health care payment processing system, wherein the health care provider server is electronically communicable with a premium assistor database and configured to add the health care information to the premium assistor database.

A health care payment processing system including a premium assistor database configured to store health care information pertaining to a patient, a premium assistor server electronically communicable with the premium assistor database and including a receiver electronically communicable with a health care provider server and configured to receive health care insurance information pertaining to the patient, the health care information including the patient's identity and health care insurance carrier information or health care exchange information, an adder configured to add the health care insurance information to a premium assistor database, a determiner configured to determine premium assistance eligibility of the patient for health care insurance premium payment assistance based on a status of a health care insurance premium payment determined based on the health care insurance information, a payer configured to pay a health care insurance premium payment associated with the status of the health care insurance premium payment, and at least one verifier configured to verify receipt of the health care insurance premium payment, wherein the at least one verifier or another verifier is configured to verify receipt of a health care services payment in response to the receipt of the health care insurance premium payment.

A health care payment processing system, including a receiver configured to receive a patient's health care insurance information, at least one responder configured to respond to an inquiry regarding whether the patient has health care insurance, the at least one responder configured to respond to an inquiry associated with a status of a health care insurance premium payment triggering addition of the health care insurance information to a database, a receiver configured to receive a health care insurance premium payment for a health care insurance premium the patient owes, the at least one responder configured to respond to a verification request regarding payment of the health care insurance premium, and a payer configured to pay a health care insurance claim in response to receiving payment for the health care insurance premiums.

A computer program product including a non-transitory computer-readable storage medium having encoded thereon instructions that, when executed by a processor, cause the processor to: record the health care information pertaining to the patient to the premium assistor database, request premium payment assistance eligibility information from the patient, health care provider server, or health care insurance server by providing at least one parameter for selecting the requested premium payment assistance eligibility information, wherein the requested premium payment assistance eligibility information received from the patient, health care provider server, or health care insurance server is selected based on a premium assistance eligibility parameter, and output the premium payment assistance eligibility information.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a schematic flow chart of exemplary logic for carrying out operation of a health care provider server and a premium assistor server according to the present application.

FIG. 2 illustrates another example of a schematic flow chart of exemplary logic for carrying out operation of a health care provider server and a premium assistor server according to the present application.

FIG. 3 illustrates a schematic diagram of an exemplary electronic communication network including a premium assistor server, a health care provider server, and a health insurance carrier server according to the present application.

FIG. 5 illustrates a schematic diagram of an exemplary computer for use in a health care provider server, a premium assistor server, or a health care insurance carrier server according to the present application.

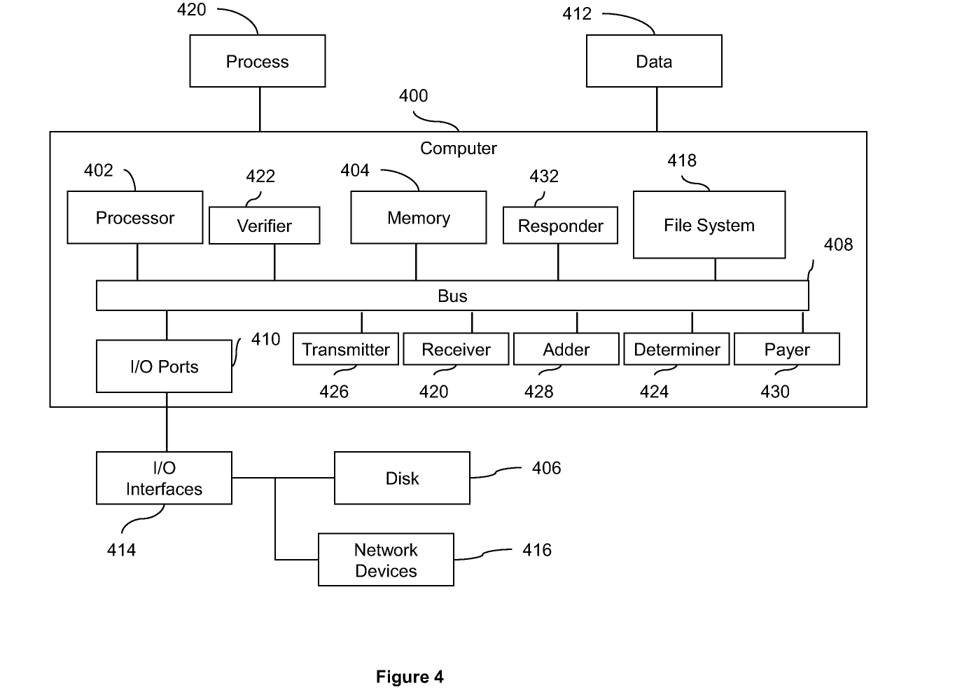

### DETAILED DESCRIPTION

As mentioned above, health care providers may provide health care service to a patient without knowing whether the patient has paid their health care insurance premium. Health care service charges a patient incurs, during a period of time the patient did not pay for their health care insurance premium, may not be paid for by the patient's health insurance carrier. Alternatively, the health care insurance carrier may pay a health care provider for the health care service charges and retroactively require reimbursement from the health care provider for the health care service charges because the patient was retroactively disenrolled from their health care insurance coverage. The present application details how these problems may be solved through the health care provider, the premium assistor, and the health care insurance carrier. For example, the premium assistor may periodically receive or periodically request the patient's health care insurance information to determine whether the patient's health care insurance premium needs to be paid and to acquire authorization to pay the health care insurance premium.

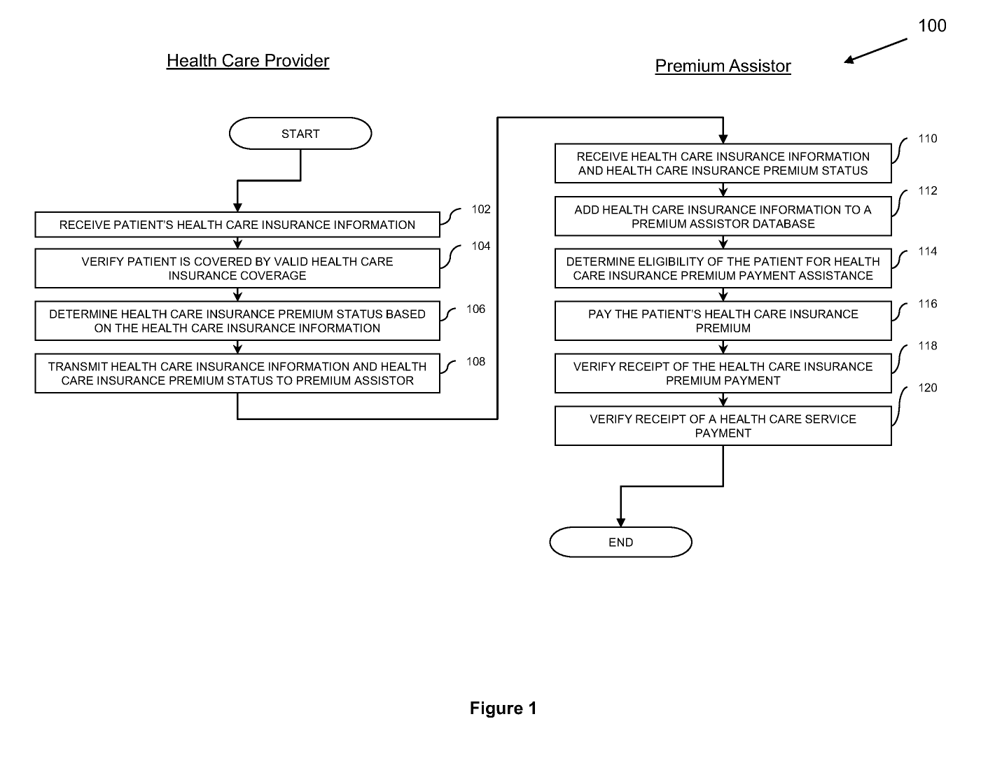

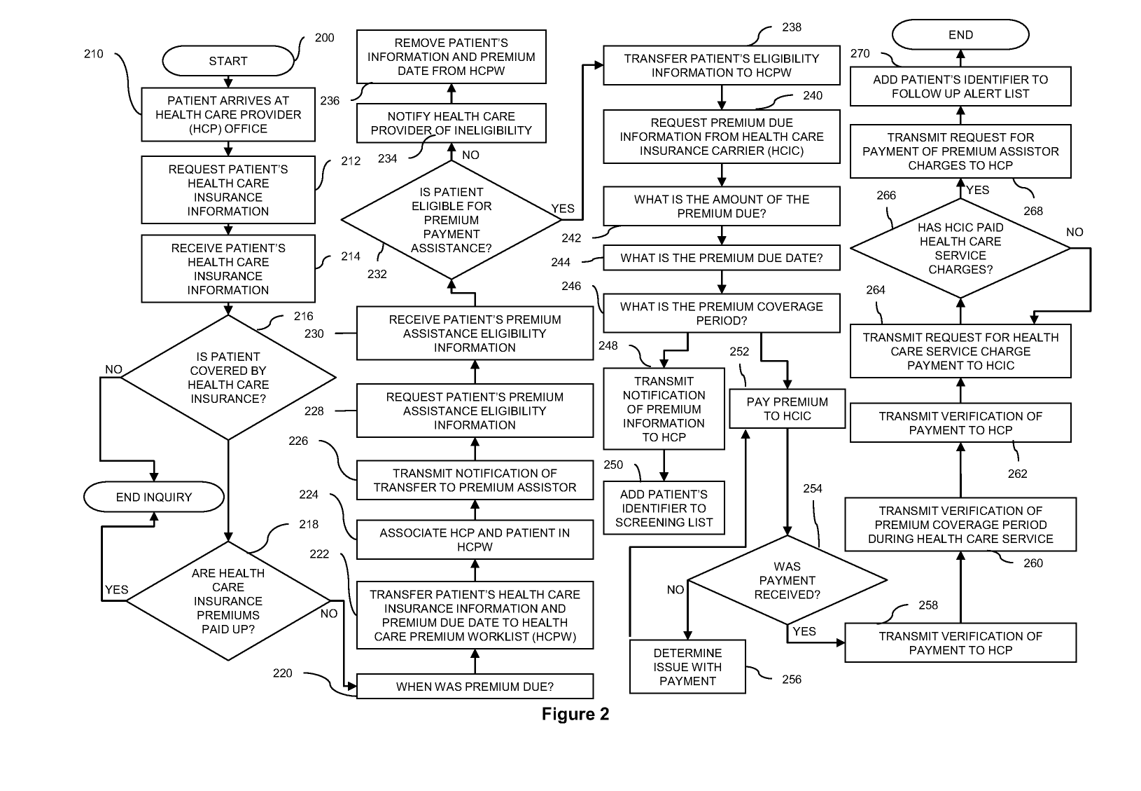

Example methods may be better appreciated with reference to the flow diagrams of FIGS. 1 and 2. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional, not illustrated blocks.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform a method that includes at least some of the steps described below.

While FIG. 1 illustrates various actions occurring in serial, it is to be appreciated that various actions illustrated in FIG. 1 could occur substantially in parallel. By way of illustration, a first process could be to receive a patient's health care insurance information 102. Similarly, a second process could be to verify the patient is covered by valid health care insurance coverage 104. A third process could be to determine a health care insurance premium status based on the health care insurance information 106. A fourth process could be to transmit health care insurance information and health care insurance premium status to a premium assistor 108. A fifth process could be to receive health care insurance information and a health care insurance premium status 110. A sixth process could be to add health care insurance information to a premium assistor database 112. A seventh process could be to determine eligibility of the patient for health care insurance premium payment assistance 114. An eighth process could be to pay the patient's health care insurance premium 116. A ninth process could be to verify receipt of the health care insurance premium payment 118. A tenth process could be to verify receipt of a health care service payment 120. While ten processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

An example of a computer implemented method of health care payment processing may include a process 102 of receiving health care insurance information pertaining to a patient. For example, a patient may provide the patient's name and a name of the patient's health care insurance carrier. The patient may also provide an assignment of health care insurance benefits or an assignment of health care insurance rights. The assignments may allow the health care provider or a premium assistor to pay the patient's health care insurance premiums on the patient's behalf. The assignments may also allow the health care provider or the premium assistor to receive payment for health care service charges on behalf of the patient. For example, a patient who has not paid their health care insurance premium may schedule a visit with a health care provider and receive health care services. The patient's failure to pay the health care insurance premium may result in disenrollment from the patient's health care insurance carrier, leaving health care service charges resulting from the received health care services unpaid by the health care insurance carrier. To retain a right to payment for the health care service rendered by the health care provider, the health care provider or the premium assistor may pay the health care insurance premiums to receive payment for health care service charges resulting from the health care services provided by the health care provider.

The health care insurance information may include the patient's identity and health care insurance carrier information or health care exchange information. The patient's identity includes any information that links the patient to the patient's health care provider or health care insurance carrier. Also, the health care insurance information may include, as mentioned above, assignments transferring rights or benefits of the patient to the health care provider or the premium assistor. The patient or a person with authority to do so may sign or otherwise authorize such assignments of rights or benefits.

In another example, the health care insurance information includes a request for reimbursement for past health care service charges paid by the health care insurance carrier. The request may be in response to the health care insurance carrier determining a health care service charge was paid in error because the patient did not have health insurance coverage at the time of the health care service.

Another process 104 may include, verifying whether the patient has valid health care insurance coverage may include contacting a health care insurance carrier, health care exchange the patient identified, or a database storing health care insurance coverage records of the patient. The identified health care insurance carrier or health care exchange may include a database storing health care insurance coverage records of the patient. At this point the health care insurance coverage may be verified. The health care insurance carrier may also be identified. For example, in some cases the patient may provide inaccurate health care insurance carrier information and during this step the correct health care insurance carrier may be identified. The health care provider may verify whether the patient has valid health care insurance coverage, but in some cases the premium assistor may verify whether the patient has valid health care insurance coverage.

Another process 106 may include, if valid health care insurance coverage is verified, then determining a status of a health care insurance premium payment for the verified health care insurance coverage may be performed. The status of the health care insurance premium payment may include information such as the last health care insurance premium coverage date paid for. In some cases this date may be months in the past indicating that the patient's health care insurance premiums are not up to date or there is an error requiring follow up. For example, the patient may have chosen not to or may have been unable to pay health care premium payments in past months.

Another process 108 may include, transmitting health care insurance information and a health care insurance status to the premium assistor. For example, the health care provider may electronically notify the premium assistor that a patient is not up to date with their health care insurance premium and recently received health care service.

Another process 110 may include, receiving health care insurance information and a health care insurance premium status. For example, the premium assistor may electronically receive the health care insurance information and the health care insurance premium status from the health care provider. The health care insurance information may include the health care insurance premium status. For example, a patient profile may be stored in a health care provider database and include a data entry for the health care insurance premium status. The premium assistor may receive the entire patient profile or only a portion of the profile such as the health care premium payment status, patient's identification information, and a summary of assignments completed by the patient or the health care provider.

Another process 112 may include, adding the health care insurance information to a premium assistor database. The premium assistor may be an entity separate from the health care provider that assists the health care provider in recovering health care service charges from health care insurance carriers. The premium assistor database may include an at risk claims work list that includes at least some health care insurance information of the patient. The added health care insurance information may indicate that the patient's health care insurance premiums are not up to date or an error exists in the patient's health care insurance information requiring follow up. The premium assistor may receive the health care insurance information and then add the health care insurance information to the at risk claims work list. Alternatively, the health care provider may add the health care insurance information to the at risk claims work list or a similar work list of the health care provider.

Another process 114 may include, determining eligibility of the patient for health care insurance premium payment assistance based on the status of the health care insurance premium payment determined based on the health care insurance information. For example, if the status of the health care insurance premium is not up to date, the patient may be determined to be eligible for health care insurance premium payment assistance. Eligibility may also include a determination based on the amount of the health care service charges recoverable if the health care insurance premium is paid. For example, if the patient incurred $50,000.00 worth of health care service in the past month and the patient did not pay any part of a $50.00 health care insurance premium for the past month, then the patient may be determined to be eligible for health care premium assistance.

Another process 116 may include, paying a health care insurance premium payment associated with the status of the health care insurance premium payment. For example, the premium assistor may pay a patient's health care insurance premium amount due for the past month to ensure the patient retains health care insurance coverage during the past month. The premium assistor may pay a health care insurance carrier on behalf of the patient or the health care provider. Alternatively, the health care provider may pay the health care insurance carrier. In a further alternative, the health care insurance carrier may debit the amount of the health care insurance premium due from the health care provider or the premium assistor.

Another process 118 may include, verifying receipt of the health care insurance premium payment. For example, the premium assistor may electronically verify funds have been transferred to the health care insurance carrier. The premium assistor may notify the health care insurance carrier of the health care insurance premium payment or request verification from the health care insurance carrier.

Another process 120 may include, verifying receipt of a health care services payment from the health care insurance carrier. For example, the premium assistor may verify funds have been transferred from the health care insurance carrier to the health care provider or the premium assistor directly. The premium assistor may request verification from the health care insurance carrier or the health care provider. In another example, the verification may include transmitting a request for receipt from the health care insurance carrier. In yet another example, the verification may include transmitting a notification of health care insurance premium payment or a statement of detrimental reliance regarding a reimbursement request by the health care insurance carrier.

The above disclosure exemplifies how the health care provider may identify and prevent providing health care service to patients without payment by receiving appropriate information and assignments from the patient and transmitting the information and assignments to the premium assistor. The above also exemplifies how the premium assistor may request the patient's information or assignments from the health care provider or directly to determine whether the patient's health care insurance premium should be paid, determine whether to pay, and determine whether to notify the health care provider that the patient should be flagged or not. The health care insurance provider may pay the premium assistor or the health care provider for a health care service charge in response to receiving payment for the patient's health care insurance premium.

FIG. 2 illustrates a more robust process that may be performed by a health care provider and a premium assistor. It is noted that the premium assistor may be a part of the same entity as the health care provider. While FIG. 2 illustrates various actions occurring in serial, it is to be appreciated that various actions illustrated in FIG. 2 could occur substantially in parallel. By way of illustration, a first process could be when the patient arrives at the health care provider office 210. Similarly, a second process could be a request for patient's health care insurance information 212. A third process could be to receive the patient's health care insurance information 214. A fourth process could ask whether the patient is covered by health care insurance 216. If the answer to the fourth process is NO, then the process may end. If the answer to the fourth process is YES, then the process may continue. A fifth process could ask whether the patient's health care insurance premiums are paid up 218. If the answer to the fifth process is YES, then the process may end. If the answer to the fifth process is NO, then the process may continue. A sixth process may ask when was the premium due 220. A seventh process could transfer the patient's health care insurance premium information and premium due date to a health care premium work list 222. An eighth process could be to associate the health care provider and the patient in the health care premium work list 224. A ninth process could be to transmit a notification of transfer to the premium assistor 226. A tenth process could be to request the patient's premium assistance eligibility information 228. An eleventh process could be to receive the patient's premium assistance eligibility information 230. A twelfth process could be to ask whether the patient is eligible for premium payment assistance 232. If the answer to the twelfth process is NO, then the next process could be a thirteenth process to notify the health care provider of ineligibility 234 and a fourteenth process could be to remove the patient's information and premium due date from the health care provider work list 236.

If the answer to the twelfth process is YES, then the next process could be a fifteenth process to transfer the patient's eligibility information to the health care provider work list 238. The sixteenth process could be to request premium due information from a health care insurance carrier 240. The seventeenth process could be to ask what is the amount of the premium due 242. The eighteenth process could be to ask what is the premium due date 244. The nineteenth process could be to ask what is the premium coverage period 246. The twentieth and twenty-second processes could occur substantially in parallel. The twentieth process could be to transmit a notification of the health care premium information to the health care provider 248. The twenty-first and twenty-third process could occur substantially in parallel. The twenty-first process could be to add a patient's identifier to a screening list 250. The screening list may be directly accessible by the health care provider. The twenty-second process could be to pay the health care insurance premium to the health care insurance carrier 252. The twenty-third process could be to ask whether the payment for the health care insurance carrier was received 254. If the answer to the twenty-third process is NO, then the twenty-fourth process could be to determine the issue with the payment 256 and then repeat the twenty-second process. If the answer to the twenty-third process is YES, then the twenty-fifth process could be to transmit verification of the payment to the health care provider 258. The twenty-sixth process could be to transmit a verification of the health care premium coverage period during the health care service 260. The twenty-seventh process could be to transmit a verification of payment of the health care premium payment to the health care provider 262. The twenty-eighth process could be to transmit a request for a health care service charge payment to the health care insurance carrier 264. The twenty-ninth process could be to ask has the health care insurance carrier paid health care service charges 266. If the answer to the twenty-ninth process is NO, then the twenty eighth process could be repeated. If the answer to the twenty-ninth process is YES, then the Thirtieth process could be to transmit a request for payment of premium assistor charges to the health care provider 268. The thirtieth process could be to add a patient's identifier to a follow up alert list 270. The follow up alert list may be included in a premium assistor database.

While 30 processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

Process 210 may include the patient arriving for a scheduled visit or for an emergency situation. At process 212, the patient may be asked to sign an assignment of benefits to allow the premium processor transfer patient rights regarding the patient's health care insurance coverage or health care exchange coverage. The patient may be asked during each visit the patient makes to the health care provider.

Process 218 may include after receiving the patient's health care insurance information 214, the health care provider determining whether the patient's health care insurance information includes an assignment of benefits or rights to either the health care provider or the premium assistor. The assignment of benefits may include transfer patient rights regarding exchange coverage to allow the premium assistor to make the determination of premium payment assistance eligibility. The assignment may allow the premium assistor or the health care provider to make health care premium payments on behalf of the patient. The assignment may also allow the premium assistor or the health care provider a right to collect payments for health care insurance service from a health care insurance carrier. The health care insurance information may also include a name of the patient's health insurance carrier or a name of a health care exchange the patient purchase health care insurance through. The patient may provide the information directly, or the information may be received from a database that includes at least some of the patient's health care insurance information. For example, a government database, a health care insurance carrier database, or a health care provider database may include some of the desired patient's health care insurance information. In another example, the health care provider may determine whether the patient should disclose more information or sign a new assignment based on health care insurance information received from the premium assistor.

Process 216 may include the health care insurance provider asking whether the patient is covered by health care insurance. Asking may include examining the health care insurance information, asking a government database or a health care insurance carrier database 318 whether the patient is covered by health care insurance.

Process 218 may include, after asking whether the patient is covered by health care insurance 216, the health care provider may ask whether the health care insurance premiums are paid up 218. The health care provider may request the information regarding the health care insurance premiums from a health care insurance carrier to determine a status of the health care insurance premium payment. The health care provider may determine that the health care insurance premium payment is either paid up or in arrears.

Process 220 include, asking when the health care insurance premium was due to establish a premium due date. After asking whether the health care insurance premiums are paid up 218, if the answer is NO then the health care provider may transfer the patient's health care insurance information and premium due date to a health care premium work list 222. The health care provider may act by transmitting the health care insurance information to a premium assistor. The transmission may act as a notification for the premium assistor to begin taking action. The health care provider may determine a timeframe for payment of the health care insurance premium to provide to the premium assistor.

Process 232 may include directly contacting the patient to request additional health care insurance information. The premium assistor may make several inquiries including anything regarding the patient's income level, facts and circumstances why they cannot pay, whether they have a job, or whether they cannot afford to pay the health care insurance premium. The premium assistor may determine the patient is eligible if three out of four inquiries support the patient's eligibility.

Process 238 may include the premium assistor transferring the health care insurance information and the premium assistance eligibility information to a health care premium work list to indicate the patient may be eligible for health care insurance premium payment assistance. The transfer may be transmitting a request to the health care provider for new patients for the health care premium work list. For example, the premium assistor server 312 may transmit a request to the health care provider server 308 for the health care provider server 308 to transmit health care insurance information related to each patient the health care provider determined was not up to date with their health care insurance premium payments. The premium assistor server 312 may request updates daily from the health care provider server 308. For example, each night the premium assistor server 312 may request health care insurance information from the health care provider database 310 and store the health care insurance information in the premium assistor database 314. In another example, the premium assistor server 312 syncs with the health care provider server 308 and updates in real-time. In yet another example, the health care provider server 308 may automatically transmit health care insurance information to the premium assistor server 312.

The work list may be accessible by the health care provider. For example, the health care provider may transfer the health care insurance information and premium assistance eligibility information to the health care premium work list. In another example if the premium assistor determines that the patient is eligible for health care insurance premium payment assistance, then the premium assistor transfers the health care insurance information and the premium assistance eligibility information to the health care premium work list.

In another example, if the premium assistor determines that the patient is eligible for health care insurance premium payment assistance, then the premium assistor may pay the health care insurance premium payment. For example, the premium assistor may receive premium due information from the health care insurance carrier. The premium due information may indicate the patient is behind on their health care insurance premium payments by 2 months and in 1 month the patient's health care insurance coverage will be retroactively terminated. The retroactive disenrollment date may be a date 2 months ago. The premium assistor may transmit this premium due information to the health care provider for future reference by the health care provider in accordance with the above.

The premium assistor may also verify a health care service date of the patient to ensure it is within a health care coverage period paid for with the health care insurance premium payment. For example, if the patient received health care service 1 month ago and the health care premium payment provided coverage for 1 month ago, then the health care service date is within the health care coverage period paid for with the health care insurance premium payment.

Process 248 may include the health care provider receiving a notification of premium due information from a premium assistor. For example, the premium assistor may request health care insurance information directly from the patient or from the health care insurance carrier. The premium assistor may later transmit the health care insurance information to the health care provider. For example, the premium assistor server 312 may update the health care provider server 308 each night with updated health care insurance information regarding the patient and the patient's health care premium payment status. The update may be automatic or at the request of the health care provider server 308.

Another process 250 may include, the health care provider adding an identifier of the patient to a screening list to indicate the patient received assistance from the premium assistor to pay a premium for the valid health care insurance coverage. Including the patient on the screening list may indicate the health care provider should ask additional questions of the patient or require the patient to sign additional forms. This may increase the likelihood the patient is covered by a health care insurance carrier during future health care service by the health care provider.

In some cases the patient may provide incorrect health care insurance information. For example the patient may provide information showing they have health care insurance coverage through Blue Shield and later the health care provider may discover the patient left Blue Shield and is now uninsured or insured through United Healthcare. The health care provider may determine whether the patient transferred coverage to another health insurance carrier. This determination may be made initially or soon after the patient indicates their health care insurance carrier.

The premium assistor may receive premium assistance eligibility information. This information may include the last date the patient paid their health care insurance premium, the health care insurance coverage date, the amount of the health care insurance premium due, the amount of health care service charges the patient acquired, and whether the patient signed assignments of health care rights and health care benefits to either the health care provider or the premium assistor.

In some cases the premium assistance eligibility information does not include an assignment of benefits. In response, the premium assistor may request and receive an assignment of benefits from the patient or a third party. For example, the premium assistor may contact the patient directly, the health care provider, or the health care insurance carrier to receive the assignment of benefits. The assignment of benefits may include transfer patient rights regarding exchange coverage to allow the premium assistor to make the determination of premium payment assistance eligibility.

Another process 264 may include the premium assistor may transmitting a request for at least a portion of a health care service charge associated with the patient to the health care insurance carrier. The request may be one behalf of the health care provider or for payment directly to the premium assistor.

In some situations the health care insurance carrier may require additional information or verification. For example if the health care insurance carrier denies a payment request or requests additional information, then the premium assistor may transmit the additional information to the health care insurance carrier. For example, the insurance carrier may request a verification of the health service date, that a health care insurance premium was properly paid to the health care insurance carrier, or that the premium assistor had proper authorization. The premium assistor may need to transmit proof that the premium assistor has the authority to pay a health care premium or the authority to receive payment from the health insurance carrier.

The premium assistor may request payment directly from the health insurance carrier or the health care provider. The request for payment may be made after the premium assistor verifies the health care insurance carrier paid a health care service charge to the health care provider. For example, after the health care insurance carrier pays the health care provider for a patient's health care service 1 month ago for $10,000.00, then the premium assistor may transmit a request to the health care provider to pay $1,000.00 in premium assistor charges to the premium assistor.

After the premium assistor pays a health care premium on behalf of the patient, the premium assistor may add an identifier of the patient to a follow up alert list. The follow up alert list may be accessible to the premium assistor and the health care provider to provide notice to the health care provider that the patient has received health care premium payment assistance in the past.

In some cases a patient may switch health insurance carriers, but fail to initially disclose this to the health care provider. If the patient transfers health insurance coverage to another health care insurance carrier, then the health care provider or the premium assistor may request a health care insurance information from the another health care insurance carrier. The health care provider or premium assistor may also request retroactive authorization to provide health care service to the patient and later request payment from the health care insurance carrier. For example, the patient may receive health care service 2 months ago, and 1 month ago the health care provider discovers the patient has health insurance coverage 2 months ago with the another health care insurance carrier than provided to the health care provider. In this case, the health care provider or the premium assistor may request retroactive authorization of treatment and later bill the another health care insurance carrier.

The premium assistor may scan a health care provider database, a government health care database, and a health care insurance carrier database to identify at risk claims. For example, the premium assistor may scan a health care provider database daily for at risk claims of health care service to uninsured patients.

The premium assistor may verify the health care provider has a signed an assignment of benefits. For example, the premium assistor may include a copy of assignments pertaining to each patient and may examine and verify that the health care provider has a signed the assignment of benefits.

The health care insurance carrier process health insurance payments by receiving health care insurance information pertaining to a patient. The health care insurance information may include the patient's identity and health care insurance carrier information or health care exchange information. After receiving the health care insurance information the health care insurance carrier may receive an inquiry regarding whether the patient has health care insurance. The health care insurance carrier may continue processing by responding to the inquiry regarding whether the patient has health care insurance. The response may include an affirmative YES or NO answer.

The health care insurance carrier may receive an inquiry regarding a status of a health care insurance premium payment of the patient. The health care insurance carrier may continue by responding to the inquiry associated with the status of the health care insurance premium payment, which may trigger addition of the health care insurance information to a database. The premium assistor may add the health care insurance information to the premium assistor database.

The premium assistor may pay the health care premium and the health care insurance carrier may receive the health care insurance premium payment for a health care insurance premium the patient owes. The health care insurance premium payment may require the health care insurance carrier to pay a health care services charge of the patient. After receiving the payment, the health care insurance carrier may continue by responding to a verification request regarding payment of the health care insurance premium. The health care insurance carrier may respond with a YES, NO, or by paying a health care insurance claim in response to receiving payment for the health care insurance premiums. For example, the premium assistor may pay the health care premium for the patient and the health care insurance carrier may pay the health care provider or the premium assistor at least a portion of a health care service charge.

Any of the above communications including any transmitting, receiving, verifying, determining, or asking may include an encryption protocol to protect the communications. For example, if the premium assistor server 312 transmits health care insurance information to the health care provider server 308, then the transmission may be encrypted to a level compliant with the Health Insurance Portability and Accountability Act (“HIPPA”).

The above method may allow the premium assistor access to patient health care insurance information, which may include authorization to pay the patient's health care insurance premium in a timely manner to premium loss of the health care provider's rights to health care service charges. Further, the above method may allow the premium assistor to request or receive payment from the health care insurance carrier for the health care service charges.

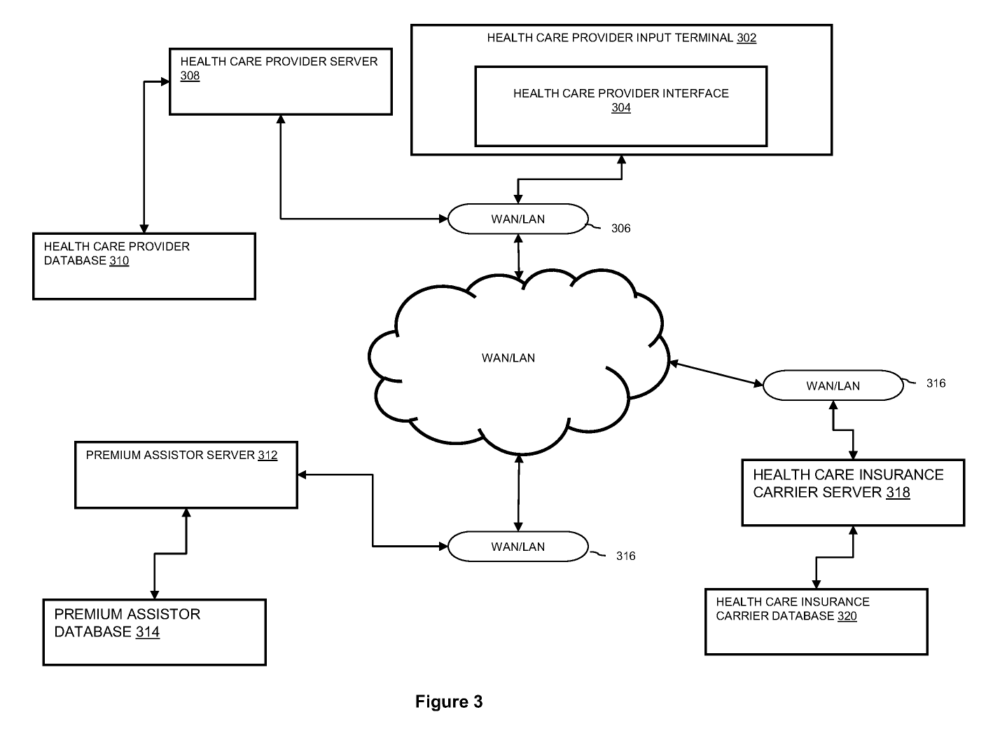

FIG. 3 illustrates a health care provider input terminal 302 with a health care provider interface 304 to facilitate a user inputting data into the Health care provider input terminal 302. The health care provider input terminal 302 is operably connected to a Wide Area Network/Local Area Network (“WAN/LAN”) 306, which may be a part of the Internet or a different WAN/LAN. The health care provider input terminal may be operably connected to a health care provider server 308 directly or through the WAN/LAN 306, which in turn may be operably connected to a health care provider database 310. The health care provider database 310 may include a health care provider work list. The health care provider database 310 may also include a health care provider screening list.

A premium assistor server may be operably connected to a premium assistor database 314. The premium assistor database 314 may include an at risk claims work list. The premium assistor server 312 may be operably connected to a WAN/LAN 316, which may be operably connected to the Internet or a different WAN/LAN.

A health care insurance carrier server 318 may be operably connected to a health care insurance carrier database 320. The health care insurance carrier database 320 may include health care insurance information regarding patient's health care insurance coverage and health care insurance premiums due. The health care insurance carrier server 318 may be operably connected to a WAN/LAN 322, which may be operably connected to the Internet or a different WAN/LAN.

The health care provider database 310, the premium assistor database 314, and the health care insurance carrier database 320 may all be operably connected to one another, as mentioned above. In another example, a single database may include the health care provider database 310 and the premium assistor database 314. In another example a single database include the health care provider database 310, the premium assistor database 314, and the health care insurance carrier database 320.

FIG. 4 illustrates a computer environment that may serve as the health care provider input terminal 302, the health care provider server 308, the premium assistor server 312 or the health care insurance carrier server 318. FIG. 4 illustrates a computer 400 that includes a processor 402, a memory 404, I/O Ports 410, a receiver 420, a verifier 422, a determiner 424, a transmitter 426, an adder 428, and a payer 430 operably connected by a bus 408. In one example, the computer 400 may include a file system 418 configured to facilitate health care payment processing. The receiver 420, verifier 422, determiner 424, transmitter 426, adder 428, and payer 430 may be permanently or removably attached to the computer 400.

The receiver 420, whether implemented in computer 400 as hardware, firmware, software, or a combination thereof may provide means for receiving health care insurance information pertaining to a patient, the health care insurance information. The receiver 420 may provide means for receiving notification of premium due information from a premium assistor. The receiver 420 may provide means for receiving premium assistance eligibility information. The receiver 420 may provide means for receiving a health care insurance premium payment for a health care insurance premium the patient owes. The receiver 420 may provide means for receiving the health care insurance premium payment from a premium assistor for a health care insurance premium the patient owes. The receiver 420 may provide means for receiving electronic communications with a health care provider server 308.

The verifier 422, whether implemented in computer 400 as hardware, firmware, software, or a combination thereof may provide means for verifying whether the patient has valid health care insurance coverage. The verifier 422 may provide a means for verifying receipt of the health care insurance premium payment. The verifier 422 may provide a means for verifying receipt of the health care insurance premium payment. The verifier 422 may provide a means for verifying receipt of a health care services payment from the health care insurance carrier. The verifier 422 may provide a means for verifying receipt of a health care services payment in response to the receipt of the health care insurance premium payment.

The verifier 422 may provide a means for verifying the patient has valid health care insurance coverage. The verifier 422 may provide a means for verifying a health care service date of the patient is within a health care coverage period paid for with the health care insurance premium payment. The verifier 422 may provide a means for verifying a request for at least a portion of a health care service charge associated with the patient is processing in the ordinary course of business. The verifier 422 may provide a means for verifying that the health care provider has a signed assignment of benefits.

The determiner 424, whether implemented in computer 400 as hardware, firmware, software, or a combination thereof may provide means for determining a status of the health care insurance premium payment. The determiner 424 may provide a means for determining a status of a health care insurance premium payment for verified health care insurance coverage. The determiner 424 may provide a means for determining eligibility of the patient for health care insurance premium payment assistance based on the status of the health care insurance premium payment determined based on the health care insurance information. The determiner 424 may provide a means for determining a status of a health care insurance premium payment based on the health care insurance information.

The determiner 424 may provide a means for determining whether the patient's information includes an assignment of benefits. The determiner 424 may provide a means for determining the premium payment status is in arrears. The determiner 424 may provide a means for determining whether the patient transferred coverage to another health insurance carrier. The determiner 424 may provide a means for determining eligibility of the patient for health care insurance premium payment assistance based on a status of a health care insurance premium payment for verified health care insurance coverage.

The transmitter 426, whether implemented in computer 400 as hardware, firmware, software, or a combination thereof may provide means for transmitting health care insurance information to a premium assistor. The transmitter 426 may provide means for transmitting notification of premium due information to a health care provider. The transmitter 426 may provide means for transmitting a request for at least a portion of a health care service charge associated with the patient to the health care insurance carrier. The transmitter 426 may provide means for transmitting additional information to the health care insurance carrier. The transmitter 426 may provide means for transmitting a request for payment of premium assistor charges to the health care provider. The transmitter 426 may provide means for transmitting a request for payment of premium assistor charges to the health care provider.

The transmitter 426 may provide means for transferring the health care insurance information and the premium assistance eligibility information to a health care premium work list to indicate the patient may be eligible for health care insurance premium payment assistance. The transmitter 426 may provide means for transferring the health care insurance information and the premium assistance eligibility information to the health care premium work list.

The adder 428, whether implemented in computer 400 as hardware, firmware, software, or a combination thereof may provide means for adding an identifier of the patient to a screening list to indicate the patient received assistance from the premium assistor to pay a premium for the valid health care insurance coverage. The adder 428 may provide means for adding health care insurance information to a database. The adder 428 may provide means for adding the health care insurance information to a premium assistor database 314. The adder 428 may provide means for adding an identifier of the patient to a follow up alert list to indicate the patient received assistance from a premium assistor to pay a premium for valid health care insurance coverage.

The payer 430, whether implemented in computer 400 as hardware, firmware, software, or a combination thereof may provide means for paying a premium for the valid health care insurance coverage. The payer 430 may provide a means for paying a health care insurance premium payment associated with the status of the health care insurance premium payment. The payer 430 may provide a means for paying a health care insurance claim in response to receiving payment for the health care insurance premiums.

The premium assistor server 312 may use the receiver 420 to receive a transmission from the health care provider server 308 or the health care insurance carrier server 318. The premium assistor server may use a verifier 422 to verify information with another server. For example the verifier 422 may retrieve information from the health care insurance carrier server 318 to verify that the health care insurance carrier server 318 received a notification that the patients health care insurance premium payment was paid.

The premium assistor server 312 may also use the determiner 424 to determine eligibility of the patient for health care insurance premium payment assistance based on a status of health care insurance premium payment stored in the memory 404.

The premium assistor server 312 may also use the adder 428 to add an identifier of the patient to a follow up alert list stored in the memory 404. Alternatively, the follow up alert list may be stored in memory 404 of the health care provider server 308.

The premium assistor server 312 may use the payer 430 to pay a health care insurance premium payment for the patient. For example, the payer 430 may electronically communicate directly with the health care insurance server 318. Alternatively, the payer 430 may electronically communicate with a third party bank.

The processor 402 can be a variety of various processors including dual microprocessor and other multi-processor architectures. The memory 404 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 406 may be operably connected to the computer 400 via, for example, an I/O Interfaces (e.g., card, device) 414 and an I/O Ports 410. The disk 406 can include, but is not limited to, devices like a magnetic disk drive, a solid state disk drive, a floppy disk drive, a tape drive, a Zip drive, a flash memory card, or a memory stick. Furthermore, the disk 406 can include optical drives like a CD-ROM, a CD recordable drive (CD-R drive), a CD rewriteable drive (CD-RW drive), or a digital video ROM drive (DVD ROM). The memory 404 can store processes 420 or data 412, for example. The disk 406 or memory 404 can store an operating system that controls and allocates resources of the computer 400.

The bus 408 can be a single internal bus interconnect architecture or other bus or mesh architectures. While a single bus is illustrated, it is to be appreciated that computer 400 may communicate with various devices, logics, and peripherals using other busses that are not illustrated (e.g., PCIE, SATA, Infiniband, 1394, USB, Ethernet). The bus 408 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The computer 400 may interact with input/output devices via I/O Interfaces 414 and I/O Ports 410. Input/output devices can include, but are not limited to, a keyboard, a microphone, a pointing and selection device, cameras, video cards, displays, disk 406, network devices 416, and the like. The I/O Ports 410 can include but are not limited to, serial ports, parallel ports, and USB ports.

The computer 400 can operate in a network environment and thus may be connected to network devices 416 via the I/O Interfaces 414, or the I/O Ports 410. Through the network devices 416, the computer 400 may interact with a network. Through the network, the computer 400 may be logically connected to remote computers. The networks with which the computer 400 may interact include, but are not limited to, a local area network (LAN), a wide area network (WAN), and other networks. The network devices 416 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 416 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

The following includes definitions of selected terms employed herein. The definitions include various examples, forms, or both of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process or thread of execution and a computer component can be localized on one computer or distributed between two or more computers.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Health care insurance carrier,” as used herein, includes but is not limited to health care exchanges. It is noted that health care exchanges will open under new legislation in the United States referred to as the Affordable Care Act (“ACA”).

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Patient,” as used herein, includes but is not limited to a person receiving health care service or a person acting on behalf of the person receiving health care service. A patient may be a parent, a guardian, an authorized official, or any other entity authorized to make health care service decisions for the person receiving health care service. A patient may be a parent, a guardian, or any other entity with health insurance that covers the person receiving health care service.

“Query,” as used herein, refers to a semantic construction that facilitates gathering and processing information. A query might be formulated in a database query language like structured query language (SQL) or object query language (OQL). A query might be implemented in computer code (e.g., C#, C++, Javascript) that can be employed to gather information from various data stores or information sources.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

What is claimed is:

1. A computer implemented method of health care payment processing including the steps of:
receiving health care insurance information pertaining to a patient, the health care insurance information including:
the patient's identity; and
health care insurance carrier information or health care exchange information;
verifying whether the patient has valid health care insurance coverage; if valid health care insurance coverage is verified, then determining a status of a health care insurance premium payment for the verified health care insurance coverage;
adding the health care insurance information to a premium assistor database;
determining eligibility of the patient for health care insurance premium payment assistance based on the status of the health care insurance premium payment determined based on the health care insurance information;
paying a health care insurance premium payment associated with the status of the health care insurance premium payment;
verifying receipt of the health care insurance premium payment; and
verifying receipt of a health care services payment from the health care insurance carrier.

2. A computer implemented method of health care payment processing including the steps of:
receiving health care insurance information pertaining to a patient, the health care insurance information including:
the patient's identity; and
health care insurance carrier information or health care exchange information;
verifying the patient has valid health care insurance coverage;
determining a status of a health care insurance premium payment based on the health care insurance information; and
transmitting the health care insurance information to a premium assistor.

3. The method of health care payment processing of claim 2, further including:
determining whether the patient's information includes an assignment of benefits.

4. The method of health care payment processing of claim 2, wherein the receiving health care insurance information includes receiving at least some patient information from the patient.

5. The method of health care payment processing of claim 2, wherein the receiving health care insurance information includes receiving at least some patient information from a health care insurance carrier.

6. The method of health care payment processing of claim 2, wherein if the verifying the patient has valid health care insurance step verifies that the patient has valid health care insurance, then determining the status of the health care insurance premium payment.

7. The method of health care payment processing of claim 2, wherein if it is determined that the patient has valid health care insurance coverage, then verifying the patient has valid health care insurance coverage.

8. The method of health care payment processing of claim 2, wherein if the determining a status of the health care insurance premium payment step determines the premium payment status is in arrears, then transmitting the health care insurance information to a premium assistor.

9. The method of health care payment processing of claim 2, further including:
receiving notification of premium due information from a premium assistor.

10. The method of health care payment processing of claim 9, further including:
adding an identifier of the patient to a screening list to indicate the patient received assistance from the premium assistor to pay a premium for the valid health care insurance coverage.

11. The method of health care payment processing of claim 2, further including:
determining whether the patient transferred coverage to another health insurance carrier.

12. A computer implemented method of health care payment processing including the steps of:
receiving health care insurance information pertaining to a patient, the information including:
the patient's identity; and
health care insurance carrier information or health care exchange information;
adding the health care insurance information to a premium assistor database;
determining eligibility of the patient for health care insurance premium payment assistance based on a status of a health care insurance premium payment for verified health care insurance coverage;
paying a health care insurance premium payment associated with the status of the health care insurance premium payment;
verifying receipt of the health care insurance premium payment; and
verifying receipt of a health care services payment from a health care insurance carrier.

13. The method of health care payment processing of claim 12, further including:
receiving premium assistance eligibility information.

14. The method of health care payment processing of claim 13, wherein if the premium assistance eligibility information does not include an assignment of benefits, then receiving an receiving an assignment of benefits from the patient or a third party.

15. The method of health care payment processing of claim 13, further including:
transferring the health care insurance information and the premium assistance eligibility information to a health care premium work list to indicate the patient may be eligible for health care insurance premium payment assistance.

16. The method of health care payment processing of claim 15, wherein if the determining eligibility of the patient for health care insurance premium payment assistance step determines that the patient is eligible for health care insurance premium payment assistance, then transferring the health care insurance information and the premium assistance eligibility information to the health care premium work list.

17. The method of health care payment processing of claim 13, wherein the receiving premium assistance eligibility information includes receiving at least some patient information from the patient.

18. The method of health care payment processing of claim 13, wherein the receiving premium assistance eligibility information includes receiving at least some patient information from the health care insurance carrier.

19. The method of health care payment processing of claim 12, wherein if the determining eligibility of the patient for health care insurance premium payment assistance step determines that the patient is eligible for health care insurance premium payment assistance, then paying the health care insurance premium payment.

20. The method of health care payment processing of claim 12, further including:
receiving premium due information from the healthcare insurance carrier.

21. The method of health care payment processing of claim 20, further including:
transmitting notification of premium due information to a health care provider.

22. The method of health care payment processing of claim 12, further including:
verifying a health care service date of the patient is within a health care coverage period paid for with the health care insurance premium payment.

23. The method of health care payment processing of claim 22, further including:
transmitting a request for at least a portion of a health care service charge associated with the patient to the health care insurance carrier.

24. The method of health care payment processing of claim 23, wherein if the request for at least a portion of a health care service charge associated with the patient denied or the health care insurance carrier requires additional information, then transmitting the additional information to the health care insurance carrier.

25. The method of health care payment processing of claim 12, further including:
transmitting a request for payment of premium assistor charges to the health care provider.

26. The method of health care payment processing of claim 25, wherein if verifying receipt of the services payment from the health care insurance carrier step verifies the receipt of the services payment, then transmitting the request for payment of premium assistor charges to the health care provider.

27. The method of health care payment processing of claim 12, further including:
adding an identifier of the patient to a follow up alert list to indicate the patient received assistance from a premium assistor to pay a premium for valid health care insurance coverage.

28. The method of health care payment processing of claim 12, wherein if the patient transferred coverage to another health care insurance carrier, then receiving benefit verification and retroactive authorization of treatment and billing the another health care insurance carrier.

29. The method of health care payment processing of claim 12, further including:
verifying a request for at least a portion of a health care service charge associated with the patient is processing in the ordinary course of business;

30. The method of health care payment processing of claim 12, wherein if incomplete health care insurance information is received from a health care provider, then receiving health care insurance information pertaining to the patient from other than the health care provider.

31. The method of health care payment processing of claim 12, further including:
scanning hospital database to identify at risk claims.

32. The method of health care payment processing of claim 12, further including:
verifying that the health care provider has a signed assignment of benefits.

33. A computer implemented method of health care payment processing including the steps of:
receiving health care insurance information pertaining to a patient, the health care insurance information including:
the patient's identity; and
health care insurance carrier information or health care exchange information;
responding to an inquiry regarding whether the patient has health care insurance;
responding to an inquiry associated with a status of a health care insurance premium payment triggering addition of the health care insurance information to a database;
receiving the health care insurance premium payment from a premium assistor for a health care insurance premium the patient owes;
responding to a verification request regarding payment of the health care insurance premium; and
if the health care insurance premium payment is received, then paying a health care insurance claim in response to receiving payment for the health care insurance premiums.

34. A health care payment processing system, including:
a health care provider database configured to store health care information pertaining to a patient and configured to store received health care insurance information pertaining to the patient;
a health care provider server electronically communicable with the health care provider database and configured to receive health care insurance information pertaining to the patient including:
a receiver electronically communicable with a health care provider server and configured to receive health care insurance information pertaining to the patient, the health care information including:
the patient's identity; and
health care insurance carrier information or health care exchange information;
a verifier configured to verify the patient has valid health care insurance coverage;
a determiner configured to determine a status of a health care insurance premium payment for the verified health care insurance coverage; and
a transmitter configured to transmit the health care insurance information to a premium assistor.

35. The health care payment processing system of claim 34, wherein the health care provider server is electronically communicable with a premium assistor database and configured to add the health care information to the premium assistor database.

36. A health care payment processing system, including:
a premium assistor database configured to store health care information pertaining to a patient;
a premium assistor server electronically communicable with the premium assistor database and including:
a receiver electronically communicable with a health care provider server and configured to receive health care insurance information pertaining to the patient, the health care information including:
the patient's identity; and
health care insurance carrier information or health care exchange information;
an adder configured to add the health care insurance information to a premium assistor database;
a determiner configured to determine premium assistance eligibility of the patient for health care insurance premium payment assistance based on a status of a health care insurance premium payment determined based on the health care insurance information;
a payer configured to pay a health care insurance premium payment associated with the status of the health care insurance premium payment; and
at least one verifier configured to verify receipt of the health care insurance premium payment;
wherein the at least one verifier or another verifier is configured to verify receipt of a health care services payment in response to the receipt of the health care insurance premium payment.

37. A health care payment processing system, including:
a receiver configured to receive a patient's health care insurance information;
at least one responder configured to respond to an inquiry regarding whether the patient has health care insurance;
the at least one responder configured to respond to an inquiry associated with a status of a health care insurance premium payment triggering addition of the health care insurance information to a database;
a receiver configured to receive a health care insurance premium payment for a health care insurance premium the patient owes;
the at least one responder configured to respond to a verification request regarding payment of the health care insurance premium; and
a payer configured to pay a health care insurance claim in response to receiving payment for the health care insurance premiums.

38. A computer program product including a non-transitory computer-readable storage medium having encoded thereon:
instructions that, when executed by a processor, cause the processor to:
record the health care information pertaining to the patient to the premium assistor database;
request premium payment assistance eligibility information from the patient, health care provider server, or health care insurance server by providing at least one parameter for selecting the requested premium payment assistance eligibility information, wherein the requested premium payment assistance eligibility information received from the patient, health care provider server, or health care insurance server is selected based on a premium assistance eligibility parameter; and
output the premium payment assistance eligibility information.
